(19) United States
(12) Patent Application Publication
(10) Pub. No.: US 2003/0172041 A1
(43) Pub. Date: Sep. 11, 2003

(54) College application planner and organizer

(76) Inventors: Paula Jean Dicrosta, Harrington Park, NJ (US); Mary Elizabeth Harrington, Harrington Park, NJ (US)

Correspondence Address: Paula Jean Dicrosta, 208 Martha Road, Harrington Park, NJ, 07640, US

(21) Appl. No.: 10/375,548

(22) Filed: Feb. 27, 2003

Related U.S. Application Data
(60) Provisional application No. 60/360,216, filed on Feb. 27, 2002.

(51) Int. Cl. G06F 17/00

(52) U.S. Cl. 705/500

(57) ABSTRACT

A method and system for assisting an individual such as a high school student or parent with the college application process. The method comprises providing in a container or box: a plurality of General Information Folders of a first color; a plurality of indexing members for the General Information Folders; a plurality of College Information Folders of a second color that is distinctive from the first color of the General Information Folders; and a plurality of blank indexing members for use with the College Information Folders. Additionally, the method enables the individual to correlate the College Information Folders with the General Information Folders in order to organize, file and track all physical paperwork associated with the filing of a college application. The system includes the box, folders and indexing members mentioned above, along with means for correlating the College Information Folders with the General Information Folders. The method and system provide a convenient way to collect, manage and retain all college application paperwork.

### CROSS-REFERENCE TO RELATED APPLICATIONS

Applicant claims priority of Provisional Application for Patent, application serial No.: 60/360,216 filed Feb. 27, 2002.

### FIELD OF INVENTION

This invention relates to the field of college application for high school students. It particularly relates to a method of organizing, tracking and filing for the actual physical paperwork part of the college application process and to an apparatus for use with the method.

### BACKGROUND ART

Every year the process of applying to colleges becomes more sophisticated and complicated; and, the number of eligible students applying increases. The opportunity to attend college is a right and privilege of all Americans and most high school students take advantage of it.

Parents, counselors and businesses recognize that this process, which can begin as early as freshman year for some students, has many requirements that must eventually be met in varying degrees of detail. By the time most students reach their junior year the process accelerates until senior year, when tests are required, essays must be formulated, research regarding individual colleges must be found, financial aid information understood, recommendations must be garnered, applications must be filed and grades must be sent. Volumes of paperwork begin to accumulate from two sources: the student and the colleges.

Many sources, including, but not limited to: books, internet sites, test preparation services, high school guidance departments, private consultants, colleges and parents are typically involved in the college application process with the student. These sources do a reasonable job of dealing with the qualitative aspects of the college application process by addressing issues such as: college selection, testing, grades/school reports, recommendations, essay writing, interviewing, and financial aid and scholarships. However, little or nothing exists to help parents and students control the actual physical paperwork part of the process.

U.S. patent application Ser. No. 2001/00/31,458 discloses a system for assisting high school students in applying for college, comprising an intensive residential workshop for students, college mentoring assistance to high schools, assistance to colleges in the form of an expanded pool of talented applicants, an alumni training program, and a computer program and database for implementing various aspects of the system. While this system is useful for educating parents and students of what is involved in the process, it does nothing to assist that parent and student in managing of the voluminous paperwork that is required for each college application.

Thus, there is a need for a method and system of organizing, tracking and filing the actual physical, paperwork part of the college application process, and this need is now satisfied by the present invention.

### SUMMARY OF THE INVENTION

The invention relates to a method for assisting an individual such as a high school student or parent with the college application process. This method comprises the steps of providing certain items in a container or box. The items include a plurality of General Information Folders of a first color; a plurality of blank indexing members for use with the General Information Folders; a plurality of College Information Folders of a second color that is distinctive from the first color of the General Information Folders; and a plurality of blank indexing members for use with the College Information Folders. Additionally, the College Information Folders are correlated with the General Information Folders in order to enable the individual to organize, file and track all physical paperwork associated with the filing of a college application.

The invention also relates to a college application system for assisting an individual such as a high school student or parent with the college application process. This system includes the box, folders and indexing members mentioned above, along with means for correlating the College Information Folders with the General Information Folders. This system presents a convenient way to collect, manage and retain all college application paperwork.

### BRIEF DESCRIPTION OF DRAWINGS

The accompanying drawings, which are incorporated in and constitute a part of this specification, illustrate the particular embodiments of the invention, and together with the description, serve to explain the principles of the invention.

FIG. 1 depicts the basic arrangement and set-up of the invention. Specific Printed Materials according to the invention are filed into the General Information Folders and stored in the Corrugated Box. Similarly, other Printed Materials are filed into the College Information Folders, and stored in the Corrugated Box.

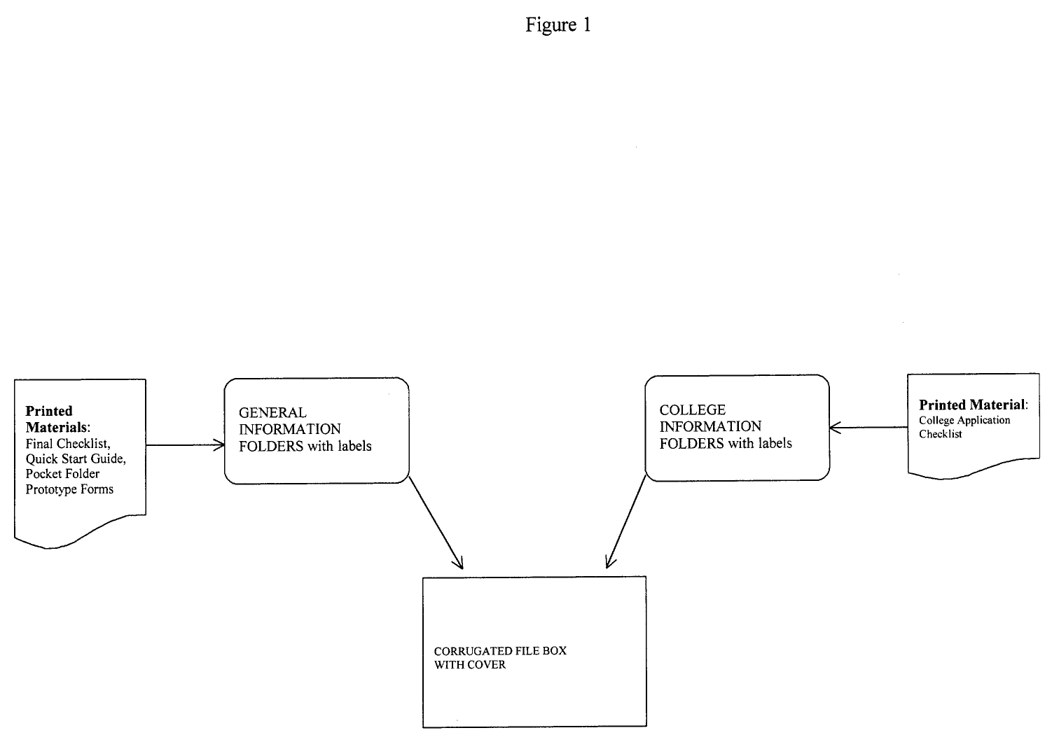

FIG. 2 depicts the flow of data from outside sources (indicated by broken lines) to the Invention. Student Data from outside sources (tests, information from guidance, essays, resume and other related information) is sorted and filed into the General Information Folders, and stored in the Corrugated Box. College Data from outside sources (view books, on-line printouts, applications, etc.) is sorted by college name and filed into the College Information Folders, and stored in the Corrugated Box.

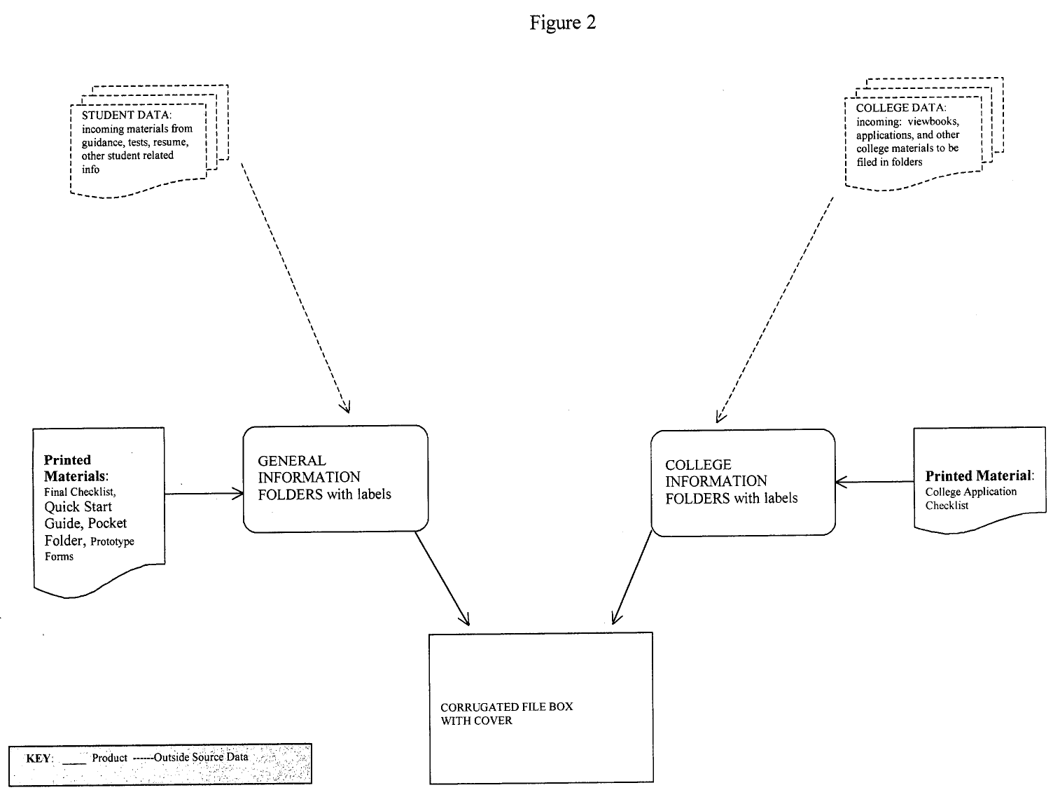

FIG. 3 depicts the flow of data: from outside sources, (indicated by broken lines) to its collection and sorting in the respective Folders, and storage in the Corrugated File Box; then, the preparation of application documents, (represented by dotted, up-down arrow boxes) takes place. Finally, the sending of all application documents flows to colleges' admissions offices (shown as the shaded box).

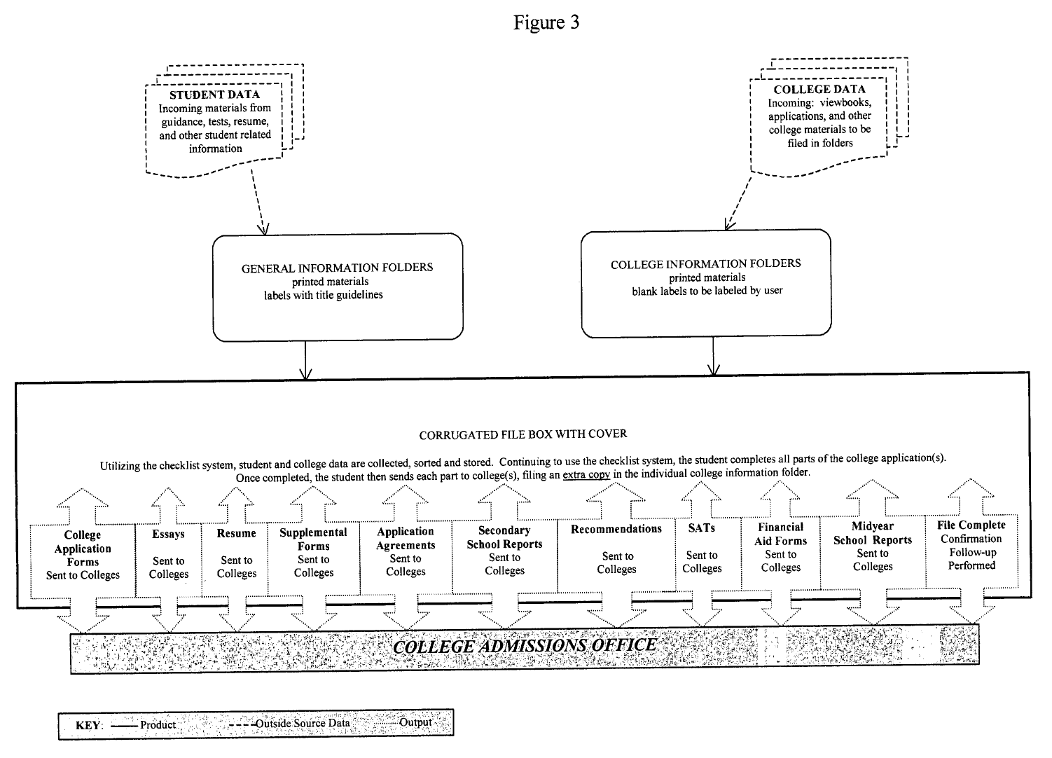

### DETAILED DESCRIPTION OF THE PREFERRED EMBODIMENTS

The invention addresses the deficiencies of the prior art by providing parents and students with a schematic diagram and storage tool by which they can monitor the activity flow during the course of the application process. Specifically, this invention:

1) Allows parents and students to set up and organize everything needed to handle the actual process of applying to college, from the pre-application to the post-application stage

2) Offers parents and students one physical place to sort, review and store all information pertinent to their college search

3) Supplies a management approach for the entire process which enables parents and students to be organized, and to therefore utilize precious time to work on essays, study for tests, research colleges, etc.

4) Provides parents and students with a specific, itemized list and guide of college application tasks so that users can see what, when, and how something must be done

5) Provides parents and students a checklist summary that enables them to track the status of their application tasks so that they see at a glance what has been done, and what remains to be completed

6) Allows parents and students to see at a glance “file complete” status

7) Helps parents and students avoid the most common errors and mistakes: misplacing important information, missing deadlines, and failing to submit all components of the application.

The invention also provides parents and students with a ready-made kit to control the activity flow during the application process. The primary benefit of using this invention is that all materials are collected and organized so that they can be consolidated to arrive at the college on time and properly completed.

Other important benefits that accrue as a result of properly utilizing of this invention are that it:

1) insures sufficient time to secure financial aid and scholarship money

2) precludes possibility of being “closed out” of rolling admissions

3) allows for margin of error in the area of sending and receiving information and

4) provides peace of mind and stress reduction that comes from being in control of the process.

The most preferred arrangement for the kit of the invention is described as follows:

Physical Components:

GENERAL INFORMATION FOLDERS:

6 letter size, hanging folders of one color with tabs

5 folders have tab inserts and suggested titles, 1 folder has blank tab insert

COLLEGE INFORMATION FOLDERS:

6 letter size hanging folders of another color, with tabs and blank tab inserts

1 Flat Corrugated File Box (pop-up style) and cover; box can be easily constructed to hold all folders and eventual college material

Printed materials as detailed in “Printed Organizational Materials” section

Pocket Folder

2 Plastic U Channel Side Rails for file box; this allows hanging folders to slide easily within the box

Explanation of Use of Physical Components:

GENERAL INFORMATION FOLDERS:

The General Information Folders are deemed to represent data collection that is student generated, student initiated, or student monitored. The number of folders to be utilized depends upon the number of different categories of information that the candidate wishes to organize, and six (6) folders are generally suitable but as high as 10 or more can be used if necessary or desired.

All of the General Information Folders, and their plastic tabs, will be a distinctive color, such as yellow, to set them apart immediately and distinctly from the remaining contents of the box.

At least five of the General Information Folders will be labeled by the user as follows:

1) “Final Checklist/Guide”

2) “SATs/Resume/Activities”

3) “Guidance & Teacher Information”

4) “Essays & Short Answers”

5) “Financial Aid/Scholarship”

The user will sort and store information received by or generated by the student into the appropriate folder.

For the sixth folder, the user will decide the title, based on his specific need, and write this on the blank insert provided.

COLLEGE INFORMATION FOLDERS:

Six (6) College Information Folders are deemed to represent data collection that emanates from colleges. While six folders are suggested, the user can include more or less folders depending upon the number of colleges to which the student plans to apply. In most cases, this number varies from 1 to 12. Of course, the present arrangement would be more useful when a student is applying to a larger number of schools so that both the student and parent are assisted in collecting, organizing and collating the necessary application materials.

The data to be sorted and stored in these folders will consist of, but not be limited to: view books, brochures, applications, scholarship and financial aid information from a specific college, and correspondence.

All of the College Information Folders will be a color other than that of the General Information Folders to set them apart immediately and distinctly from the remaining contents of the box, e.g., blue or green when yellow is used for the General Information Folders.

The user must select the specific colleges that he or she expects to apply to, type or write the name of the college on the insert, place the insert into the tab, and place one tab on each folder. Then the College Information Folders will be ready for the user to employ.

FLAT CORRUGATED FILE BOX

A Corrugated Box (approximate dimensions: 13¼″×15″×10¾“), designed to pop-up for use as a receptacle, with a cover, will unify the General Information and College Information Folders in one place. The preferred size is sufficient to hold all of the preceding folders, but this may be varied depending upon the amount of written materials and the number of folders. If necessary, more than one box can be used.

The “General Information Folders” are preferably placed in the front of the box, while the “College Information Folders” are placed behind the “General Information Folders.”

The following Printed Organizational Materials are also included:

Quick Start Guide including Directions for use of the kit

College Application Checklist for each college folder

Final Checklist

Prototype Forms

Resume

College Address and Contacts List

Thank You Notes

College Comparison Sheet

Password Summary Sheet

Student Highlights Summary

Interview/Campus Visits Planning Sheet

The “Quick Start Guide” provides succinct, and chronological instructions for using the kit. File in the folder labeled “Final Checklist/Guide.”

The “College Application Checklist” provides a list of each task that must be completed for each college, from the pre-application stage to the post application stage. Six (6) sheets will be provided. One will be filed as the first page of each “College Information Folder”.

The “Final Checklist” provides a detailed overview of every general task that must be attended to for each college, on one page, and a place to check off, or write in a date when task is complete. File in the folder labeled “Final Checklist/Guide.”

The “Prototype Forms” provide an array of ready-made forms that can be selected and adapted by user for use on an as needed basis. Each form should be filed according to its category of use.

SEMINAR, CD, AND VIDEO

If desired, a one to two hour seminar primarily directed to student or parent groups can be provided to explain the necessary features of the present system and method. A Compact Disk (CD) can also be provided that will include the “Quick Start Guide,” and an interactive and printable form of the Checklists and Prototype forms.

What is claimed is:

1. A method for assisting an individual such as a high school student or parent with the college application process, comprising:
providing in a container or box:
a plurality of General Information Folders of a first color;
a plurality of indexing members for the General Information Folders;
a plurality of College Information Folders of a second color that is distinctive from the first color of the General Information Folders; and
a plurality of blank indexing members for use with the College Information Folders; and
correlating the College Information Folders with the General Information Folders in order to enable the individual to organize, file and track all physical paperwork associated with the filing of a college application.

2. A college application system for assisting an individual such as a high school student or parent with the college application process, comprising:
a plurality of General Information Folders of a first color;
a plurality of indexing members for the General Information Folders;
a plurality of College Information Folders of a second color that is distinctive from the first color of the General Information Folders;
a plurality of blank indexing members for use with the College Information Folders;
means for correlating the College Information Folders with the General Information Folders; and
a container or box for housing the General Information Folders and the College Information Folders together;
wherein the correlation of the College Information Folders and the General Information Folders enables the individual to organize, file and track all physical paperwork associated with the filing of a college application.
